(19) United States
(12) Patent Application Publication
(10) Pub. No.: US 2024/0235313 A1
(43) Pub. Date: Jul. 11, 2024

(54) WINDING OVERHANG GUIDE, AND ASSOCIATED WOUND ROTOR AND WINDING METHOD

(71) Applicants: RENAULT S.A.S, Boulogne Billancourt (FR); NISSAN MOTOR CO., LTD., Kanagawa (JP)

(72) Inventors: Emmanuel MOTTE, Cleon (FR); Daniella VIVAS-MARQUEZ, Guyancourt Cedex (FR)

(73) Assignees: RENAULT S.A.S, Boulogne Billancourt (FR); NISSAN MOTOR CO., LTD., Kanagawa (JP)

(21) Appl. No.: 18/559,677

(22) PCT Filed: Jun. 3, 2022
(86) PCT No.: PCT/EP2022/065277

§ 371 Date: Nov. 8, 2023

(30) Foreign Application Priority Data
Jun. 8, 2021 (FR) FR2106024

(51) Int. Cl. H02K 3/52

(52) U.S. Cl. CPC H02K 3/527; H02K 2203/12

(57) ABSTRACT

A winding overhang guide is for the winding of conductive electrical wires around teeth of a wound rotor. The winding overhang guide includes a central opening for receiving a rotor shaft. Further, gadroons are arranged regularly, projecting into the central opening and arranged to deform against the shaft.

The invention relates to the winding of a rotor.

More particularly, the present invention relates to a winding overhang guide for winding of conductive electrical wires around teeth of a wound rotor, a wound rotor for a rotary electrical machine comprising a guide of this type, and a winding method which implements a guide of this type.

An electric motor with a wound rotor, such as an electrical machine used in an electric traction motor vehicle, is made of electrically conductive wires, such as enamelled copper wires. The electrically conductive wires are wound around a core made of a stack of electrically conductive plates.

In order to guarantee good positioning of the wires during the winding of the rotor, a winding overhang guide is centred and immobilised on the shaft of the rotor, in order to guarantee the positioning of the wires during the winding.

The guide is generally made of plastics material in order to prevent damage to the electrical wires.

In order to guarantee the immobilisation of the guide on the rotor shaft, the plastics guide can be shrunk onto the rotor shaft, which is generally made of metal.

However, an assembly of this type creates stresses on the guide, which can damage it and give rise to breakdown of the electric motor.

Document FR3084220 proposes moulding a plastics winding overhang winding guide around a metal part which permits shrinking of the said part onto a rotor shaft.

However, the production of an overhang winding guide of this type requires production of an additional metal part.

It is therefore proposed to overcome some or all of the disadvantages of winding overhang guides according to the prior art, in particular by proposing a winding overhang guide which is reliable and simple to produce.

In view of the foregoing, the subject of the invention is a winding overhang guide for winding of conductive electrical wires around teeth of a wound rotor, comprising a central opening which is designed to receive a rotor shaft.

Gadroons are positioned regularly projecting towards the interior of the central opening, and are configured to be deformed against the shaft.

Preferably, the opening is in the form of a truncated cone in the thickness of the guide, with the truncated cone being configured such that, during the insertion of the guide around the rotor shaft, the shaft passes firstly through the largest base of the truncated cone, with the gadroons extending according to the thickness of the guide, and the length of the gadroons being constant.

Advantageously, the winding overhang guide also comprises a groove which extends according to the thickness of the guide, between two adjacent gadroons.

Preferably, the winding overhang guide comprises at least three gadroons.

The subject of the invention is also a wound rotor for a rotary electrical machine, comprising a rotor shaft, two winding overhang guides as previously defined, and each positioned at a different end of the rotor shaft, the gadroons of the winding overhang guides being deformed on the rotor shaft in order to immobilise the rotor shaft in the openings of the guides.

The subject of the invention is also a method for winding conductive electrical wires around teeth of a wound rotor.

The method comprises the insertion of a winding overhang guide at an end of the rotor shaft of the rotor, such that the shaft deforms gadroons which are positioned regularly projecting towards the interior of a central opening of the winding overhang guide.

Preferably, the method comprises the insertion, at the other end of the rotor shaft, of a second winding overhang guide, such that the shaft deforms the gadroons of the central opening of the second winding overhang guide.

Advantageously, each winding overhang guide is inserted on the rotor shaft such that the rotor shaft passes through the largest base of the central opening in the form of a truncated cone in the thickness of the guide, with the gadroons extending according to the thickness of the guide, and having a constant length.

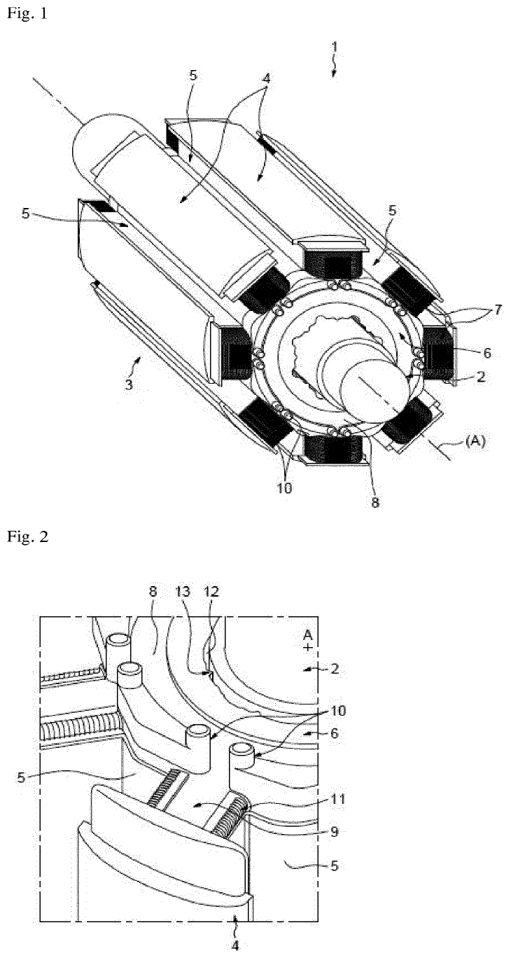

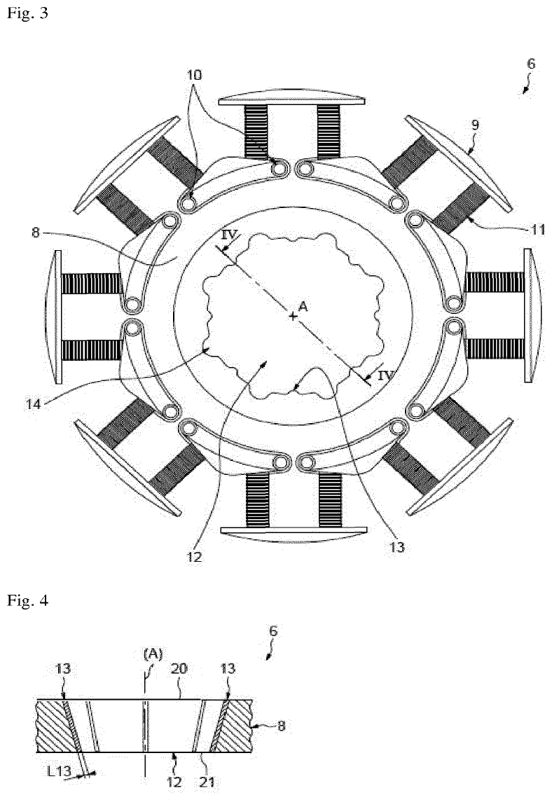

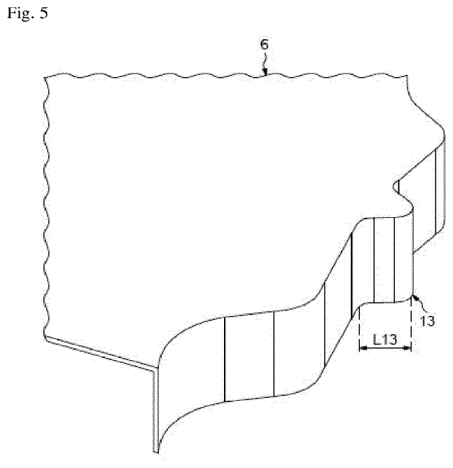

Other objectives, characteristics and advantages of the invention will become apparent from reading the following description, provided purely by way of non-limiting example, and with reference to the appended drawings, in which:

[FIG. 1] illustrates schematically an example of a wound rotor according to the invention:

[FIG. 2] illustrates schematically a partial view of an end of the rotor according to the invention;

[FIG. 3] illustrates an embodiment of the winding overhang guide according to the invention:

[FIG. 4] is a view in axial cross section of the winding overhang guide of [FIG. 3]: and

[FIG. 5] illustrates an exemplary embodiment of a gadroon according to the invention.

[FIG. 1] illustrates an example of a wound rotor 1 which is designed to be inserted in a stator of a rotary electrical machine.

The rotor 1 comprises a shaft 2 and a magnetic mass 3 which is fitted on the metal shaft 2.

The rotor I rotates according to an axis of rotation (A).

The magnetic mass 3 comprises magnetic plates forming an alteration of rotor teeth 4 and notches 5 which are positioned regularly on a diameter of the magnetic mass 3, two winding overhang guides 6, and windings 7.

In this case, the magnetic mass comprises eight rotor teeth 4.

As a variant, the magnetic mass 3 can comprise more or less than eight teeth.

The winding overhang guides 6 are positioned respectively at different ends of the rotor shaft 2, and each comprise a circular part 8 which is surmounted by guide teeth 9 (not represented), positioned regularly on the periphery of the circular part 8, with the number of guide teeth 9 being equal to the number of rotor teeth 4.

Each winding 7 is wound around a rotor tooth 4 and a guide tooth 9 of the two winding overhang guides 6, such as to form for example a rotor pole.

Each winding overhang guide 6 is immobilised on the rotor shaft 2, such that the circular part 8 and the rotor shaft 2 are concentric, and such that each guide tooth 9 coincides with a rotor tooth 4.

The winding overhang guides 6 make it possible to position wires correctly in the notch 5 during a winding step, in order to produce the windings 7.

Each winding overhang guide 6 also comprises pins 10.

The pins 10 of one of the winding overhang guides 6 makes it possible to connect some of the windings 7 to one another in order to form pairs of poles, with the pins of the other winding overhang guide 6 not being used.

Since the plastics winding overhang guides 6 are produced by moulding, a single mould is necessary in order to produce the winding overhang guides 6, independently from the use of the pins 10.

[FIG. 2] illustrates a partial view of an end of the rotor 1, with the windings 7 having been removed.

The winding overhang guide 6 also comprising guide grooves 11 positioned on the edges of each guide tooth 9 is placed such as to retain the wires of the windings 7.

The positioning of the winding overhang guides 6 on the rotor shaft 2 makes it possible to secure the start of each winding 7 in the guide grooves 11 of each guide tooth 9 in a repeatable manner.

Each winding overhang guide 6 also comprises a central opening 12 produced in the circular part 8, and accommodating the rotor shaft 2.

The central opening 12 is globally circular.

Gadroons 13 are positioned regularly projecting towards the interior of the central opening 12.

The gadroons 13 have dimensions such as to be deformed against the rotor shaft 2 during insertion of the winding overhang guide 6 around the rotor shaft 2, while being compressed against the shaft 2.

The deformation of the gadroons 13 on the rotor shaft 4 immobilises the guide 6 around the rotor shaft 2 by friction of the gadroons 13 on the rotor shaft 4, without transmitting additional stress to the guide assembly 6, thus reducing the risk of breakage of the guide 6 during the winding of the windings 7, and during rotation of the rotor 1.

In order to centre the guide 6 on the rotor shaft 2, the central opening 12 comprises at least three gadroons 13, which are offset angularly by 120° relative to the shaft (A).

FIGS. 3 and 4 illustrate respectively a view and a partial cross section in the direction IV-IV of an embodiment of the guide 6.

The guide 6 also comprises grooves 14 which extend according to the thickness of the guide 6 between two adjacent gadroons 13.

The grooves 14 make it possible to have symmetry of the rotor on both sides of the winding, in order to clear a passage for insertion of parts, comprising for example the excitation ring.

As shown in [FIG. 4], the opening 12 is in the form of a truncated cone in the thickness of the guide 6.

The truncated cone comprises a large base 20 with a diameter larger than that of the rotor shaft 4, and situated at an end of the circular part 8, and a small base 21 situated at the other end of the circular part 8, with a diameter smaller than that of the large base 20.

The gadroons 13 extend according to the thickness of the circular part 8, and have a constant length L13.

The guide 6 is inserted around the rotor shaft 4, such that the rotor shaft 4 passes firstly through the largest base 20 of the truncated cone, with a gap which facilitates centring of the guide 6 around the rotor shaft 4 during the insertion of the guide 6, then through the small base 21.

The gadroons 13 are partially compressed.

[FIG. 5] illustrates an embodiment of the gadroon 13.

Since the guide 6 is produced by moulding, the gadroon 13 comprises connection radii.

The gadroon 13 has for example a length L13 of 1 mm.

The addition of gadroons 13 makes it possible to centre the guide 6 and immobilise it on the rotor shaft 4 in order to produce the windings 7, without giving rise to additional mechanical stresses on the guide 6 which can damage the guide 6 during the step of winding and during the use of the rotor 1.

In addition, since the guide 6 without gadroons is commonly used, it is sufficient to modify the mould in order to produce the guide 6, thus reducing the production costs of the guide 6.

1-8. (canceled).

9. A winding overhang guide for winding of conductive electrical wires around teeth of a wound rotor, comprising:
a central opening which is configured to receive a rotor shaft; and
gadroons positioned regularly projecting towards an interior of the central opening, and the gadroons are configured to be deformed against the shaft.

10. The guide as claimed in claim 9, wherein the opening is in the form of a truncated cone in a thickness of the guide, with the truncated cone being configured such that, during insertion of the guide around the rotor shaft, the shaft passes firstly through a largest base of the truncated cone, with the gadroons extending according to the thickness of the guide, and a length of the gadroons being constant.

11. The guide as claimed in claim 9, further comprising a groove which extends according to a thickness of the guide, between two adjacent gadroons.

12. The guide as claimed in claim 9, wherein the guide includes at least three of the gadroons.

13. A wound rotor for a rotary electrical machine, comprising:
a rotor shaft; and
two of the guides as claimed in claim 9, each positioned at a different end of the rotor shaft, the gadroons of the guides being deformed on the rotor shaft in order to immobilise the rotor shaft in the openings of the guides.

14. A method for winding conductive electrical wires around teeth of a wound rotor, comprising:
inserting a winding overhang guide at a first end of a rotor shaft of the rotor, such that the shaft deforms gadroons which are positioned regularly projecting towards an interior of a central opening of the winding overhang guide.

15. The method as claimed in claim 14, further comprising:
inserting, at a second end of the rotor shaft, a second winding overhang guide, such that the rotor shaft deforms gadroons of a central opening of the second winding overhang guide.

16. The method as claimed in claim 14, wherein the winding overhang guide is inserted on the rotor shaft such that the rotor shaft passes firstly through a largest base of the central opening in the form of a truncated cone in a thickness of the guide, with the gadroons extending according to the thickness of the guide, and having a constant length.
